(19) United States
(12) Patent Application Publication
(10) Pub. No.: US 2023/0284573 A1
(43) Pub. Date: Sep. 14, 2023

(54) Mobile Working Machine, in Particular a Forestry Machine

(71) Applicant: Suffel Fördertechnik GmbH & Co. KG, Aschaffenburg (DE)

(72) Inventors: Michael Willenbücher, Oberzent (DE); Claus Hofmann, Haibach (DE); Bernward Welschof, Grossostheim (DE)

(21) Appl. No.: 18/005,510

(22) PCT Filed: Jul. 1, 2021
(86) PCT No.: PCT/EP2021/068176

§ 371 Date: Jan. 13, 2023

(30) Foreign Application Priority Data
Jul. 16, 2020 (DE) 10 2020 118 838.2

(51) Int. Cl. A01G 23/00; B60P 3/41; B60D 1/52; B60P 1/43; G05D 1/00

(52) U.S. Cl. CPC A01G 23/003; B60P 3/41; B60D 1/52; B60P 1/433; G05D 1/0011

(57) ABSTRACT

A mobile working machine, in particular a forestry machine, is disclosed which is provided with a chassis, a drive unit, a rope winch, a stanchion and an adjustable ramp plate located on the rear end of a vehicle body. The working machine does not have a driver workplace for an operator and is in the form of a remotely controlled working machine. The ramp plate is provided with at least one fastening interface, to which an additional stanchion can be releasably fastened, and/or the ramp plate is provided with a fastening interface to which a trailer hitch head can be releasably fastened.

### CROSS-REFERENCE TO RELATED APPLICATIONS

This application is the United States national phase of International Application No. PCT/EP2021/068176 filed Jul. 1, 2021, and claims priority to German Patent Application No. 10 2020 118 838.2 filed Jul. 16, 2020, the disclosures of which are hereby incorporated by reference in their entireties.

### BACKGROUND OF THE INVENTION

### Field of the Invention

This invention relates to a working machine, in particular a forestry machine, which is provided with a chassis, a drive unit, a rope winch, a stanchion and an adjustable ramp plate located on the rear end of a vehicle body, wherein the working machine does not have a driver workplace for an operator and is in the form of a remotely controlled working machine.

### Description of Related Art

A remotely controlled working machine of this type is known from DE 10 2018 104 810 A1.

Mobile working machines in the form of forestry machines, for example, are used for harvesting timber and forwarding the felled trees to a forest road. Because the working machine does not have a driver workplace for an operator, a working machine of this type can have a compact and lightweight construction that makes possible its use in forested areas that are not suitable for conventional large machines.

On conventional working machines, the exclusive purpose of the ramp plate is to pull a tree trunk into the stanchion cage with the rope winch. A tree trunk placed in the stanchion cage, on account of the weight of the tree trunk that is exerted on the working machine, results in high traction in spite of the low unloaded weight of the working machine.

### SUMMARY OF THE INVENTION

The object of this invention is to provide a working machine of the type described above which can be used in a more universal range of applications.

The invention accomplishes this object in that the ramp plate is provided with at least one fastening interface to which an additional stanchion is releasably fastened, and/or the ramp plate is provided with a fastening interface to which a trailer hitch head is releasably fastened.

With fastening interfaces of this type it is possible to temporarily form, on the ramp plate, a second row of additional stanchions formed by two additional stanchions, which makes it possible to transport, between the stanchions and the additional stanchions, wooden rods, such as fence posts and/or fence construction material such as chain link mesh, which are required, for example, for fencing in reforested areas. It is also possible to transport a water tank between the stanchion and the additional stanchion, to water reforested areas and newly planted trees. With the additional stanchion that can be temporarily formed, the ramp plate can therefore be used as a transport platform. With a fastening interface of this type it is alternatively or additionally possible to temporarily fasten a trailer hitch head to the ramp plate, which makes it possible to tow a trailer. With the fastening interfaces on the ramp plate and the additional stanchions or trailer hitch head that can be fastened to them, the working machine can therefore also be used as a harvester and as a forwarder for a wide range of transport tasks and is therefore suitable for a wider range of applications.

According to one embodiment of the invention, the fastening interface is formed by a receptacle sleeve located in the ramp plate, into which the additional stanchion and/or the trailer hitch head can be inserted and which is recessed into the ramp plate. In receptacle sleeves of this type, an additional stanchion or a trailer hitch can be quickly and easily inserted and extracted again, so that the working machine can be rapidly reconfigured for transport tasks. With a recessed location of the receptacle sleeve in the ramp plate, the receptacle sleeve does not project upward out of the ramp plate, so that there are no disruptive edges created by the receptacle sleeve that could interfere with the pulling of a tree trunk onto the stanchion cage.

It is advantageous if, according to one development of the invention, the additional stanchion and/or the trailer hitch head is provided with a stop flange, with which the additional stanchion and/or the trailer hitch head is in contact, when inserted, on the upper side of the receptacle sleeve. With a stop flange of this type, a stop can be formed in a simple manner that facilitates the insertion of the additional stanchions and/or of the trailer hitch head into the corresponding receptacle sleeve.

According to one development of the invention, the additional stanchion and/or the trailer hitch head can be secured in the receptacle sleeve with a locking element, in particular a cotter pin or a spring-action lock nut. The cotter pin can be in the form of a spring pin or linchpin, for example. With a locking element in the form of a cotter pin or spring-action lock nut, the additional stanchion inserted into the receptacle sleeve and/or the trailer hitch head inserted into the receptacle sleeve can be quickly and easily secured to prevent if from falling out of the receptacle sleeve.

According to a particularly advantageous embodiment of the invention, two fastening interfaces located at some distance from each other in the transverse direction of the vehicle are provided, to each of which an additional stanchion is releasably fastened. It is therefore possible, in a simple manner, to temporarily form a row of additional stanchions located on the sides of the ramp plate at some distance from each other in the transverse direction of the vehicle.

According to a particularly advantageous embodiment of the invention, a fastening interface located essentially centrally in the transverse direction of the vehicle is provided, to which a trailer hitch head is releasably fastened. This fastening interface makes it possible in a simple manner to temporarily locate a trailer hitch head on the ramp plate centrally in the transverse direction of the vehicle.

According to one advantageous development of the invention, it is particularly advantageous if the ramp plate can be supported by means of at least one support strut in an essentially horizontal position on the vehicle body of the working machine. With a support strut of this type, the ramp plate can be quickly and easily held and locked in an essentially horizontal position for transport tasks.

The support strut can be in the form of a fixed strut. It is advantageous if the support strut is in the form of a threaded strut, in particular a double-threaded strut. A threaded strut makes it possible to adjust the length of the support strut in a simple manner so that the adjustable ramp plate can be supported in a desired position for transport tasks. The threaded strut is preferably in the form of a double-threaded rod, for example a top link, which is known from tractor 3-point hydraulic systems.

According to one advantageous embodiment of the invention, the support strut can be releasably fastened to the vehicle body by means of a bolted connection and to the ramp plate by means of a bolted connection. This makes it possible to quickly and easily attach the support strut to the vehicle body and the ramp plate when necessary.

The adjustable ramp plate is preferably located on the rear end of the working machine and can be adjusted around a horizontal transverse vehicle axis.

It is advantageous if the adjustable ramp plate can be adjusted around the transverse axis of the vehicle by means of at least one hydraulic cylinder. The ramp plate can thereby easily be inclined, when necessary, around the transverse axis of the vehicle to bring it into an essentially horizontal position for transport tasks, or to lower it to the ground for forwarding operations.

The hydraulic cylinder can preferably be actuated by means of a control valve that has a floating position. In the floating position, the ramp plate lowered to the ground can follow the contour of the ground and slide along the ground, which makes it possible to travel along logging roads with the ramp plate lowered to the ground.

It is particularly advantageous if the stanchion has two vertical stanchion rods located at some distance from each other in the transverse direction of the vehicle and is mounted so that it can rotate around a vertical axis. A tree trunk can be laid in a simple manner between two such stanchion rods, when the machine is used for forwarding.

According to one development of the invention, a cross-bracing is located on the vehicle body, between the stanchion and the ramp plate in the longitudinal direction of the vehicle. The cross-bracing makes possible a torsion-resistant and stable construction of the working machine on the rear end of the vehicle on which the adjustable ramp plate is mounted and by means of which the tree trunks are pulled onto the stanchion with the rope winch or on which appropriate cargo is transported for transport tasks.

### BRIEF DESCRIPTION OF THE DRAWINGS

Additional advantages and details of the invention are described in greater detail below with reference to the exemplary embodiment illustrated in the accompanying schematic figures, in which:

FIG. 1 is a view in perspective of a mobile working machine according to the invention,

FIG. 2 is a view in perspective of the working machine from below,

FIG. 3 is a section along line A-A in FIG. 1, and

FIG. 4 is a detail of FIG. 2 in an enlarged illustration,

FIG. 5 is a section along line B-B in FIG. 1, in a perspective view, and

FIG. 6 is a section along line B-B in FIG. 1 in a side view.

### DESCRIPTION OF THE INVENTION

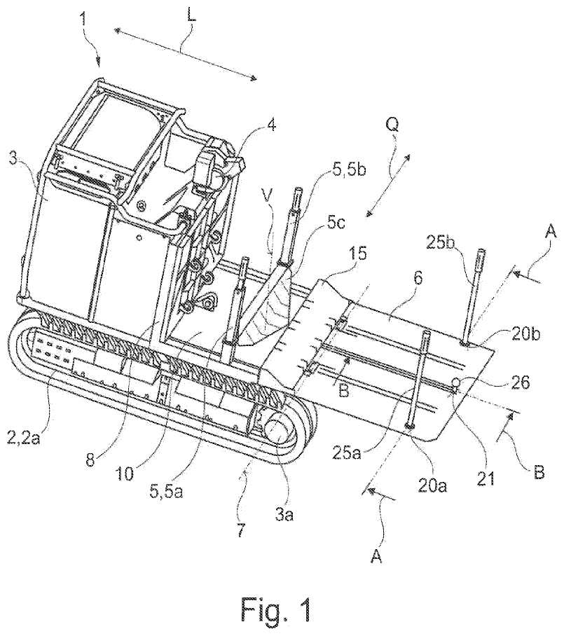

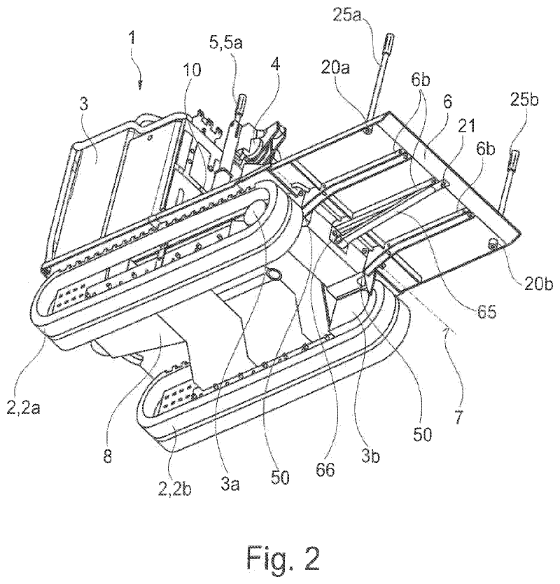

FIGS. 1 and 2 are views in perspective of a remotely controlled mobile working machine 1 according to the invention, for example a forestry machine.

The mobile working machine 1 comprises a chassis 2, which is formed by two tracks 2a, 2b, each of which is driven by a hydraulic traction drive motor 3a. 3b, for example. The traction drive motors 3a, 3b, seen in the longitudinal direction L of the vehicle, are each located on the respective rear ends of the tracks 2a, 2b, i.e. on the rear end of the vehicle.

The mobile working machine 1 has a drive unit 3, a rope winch 4, a stanchion 5 and an adjustable ramp plate 6, which is located on the rear end of a vehicle body 8 so that it can be adjusted around a horizontal transverse axis 7 of the vehicle. The working machine 1 does not have a driver workplace for an operator and can be operated remotely by an operator by means of a remote control, which is not illustrated in any further detail. The drive unit 3 can have an internal combustion engine which drives one or more hydraulic pumps which supply the traction drive motors 3a, 3b, a hydraulic motor that drives the rope winch 4 and additional hydraulic consumers of the working machine, such as hydraulic cylinders for positioning the ramp plate 6, for example.

On the front of the working machine 1 according to the invention, viewed in the longitudinal direction L of the vehicle, are the drive unit 3, adjacent to the drive unit 3 is the rope winch 4, adjacent to the rope winch 4 is the stanchion 5, and on the rear end of the vehicle is the adjustable ramp plate 6. Viewed in the longitudinal direction, therefore, the rope winch 4 is located between the stanchion 5 and the drive unit 3.

The stanchion 5 is located in the vertical direction above a base plate 10 of the vehicle body 8.

The drive unit 3 and the rope winch 4 are located in the forward half of the working machine 1. The base plate 10 with the stanchion 5 on it forms the rear half of the working machine 1.

The stanchion 5 is preferably mounted so that it can rotate around a vertical axis V. The rotatable stanchion can advantageously be locked in one or more positions by means of a locking device. In the illustrated embodiment, the stanchion 5 has two vertical stanchion rods 5a, 5b located at some distance from each other in the transverse direction Q of the vehicle, which are fastened to a cross member 5c, and which is mounted on the base plate 10 so that it can rotate around the vertical axis V.

In the longitudinal direction L of the vehicle, between the stanchion 5 and the ramp plate 6 located on the rear end of the vehicle, a cross brace 15 is also located on the top of the base plate 10.

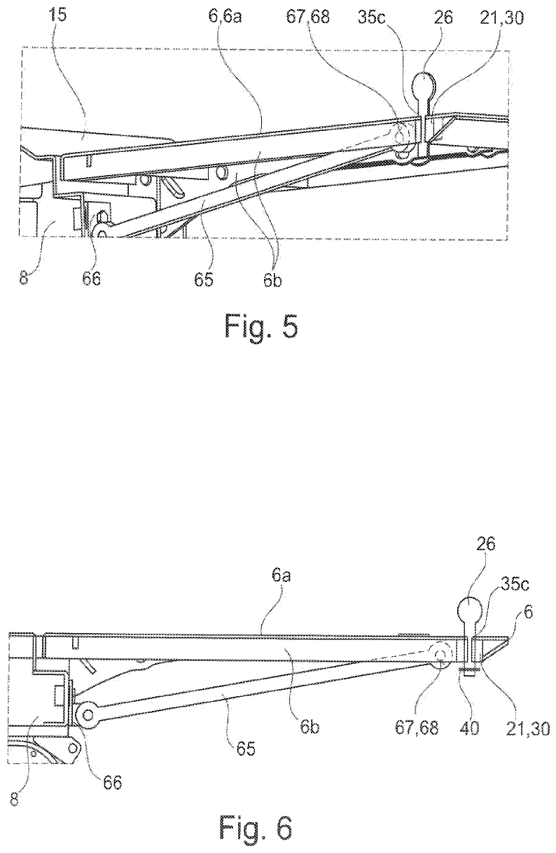

According to the invention, the ramp plate 6 is provided with at least one fastening interface 20a, 20b, 21. An additional stanchion 25a, 25b illustrated in FIGS. 1 to 3 can be releasably fastened to each fastening interface 20a, 20b. A trailer hitch head 26 illustrated in FIGS. 1, 5 and 6 can be releasably fastened to the fastening interface 21.

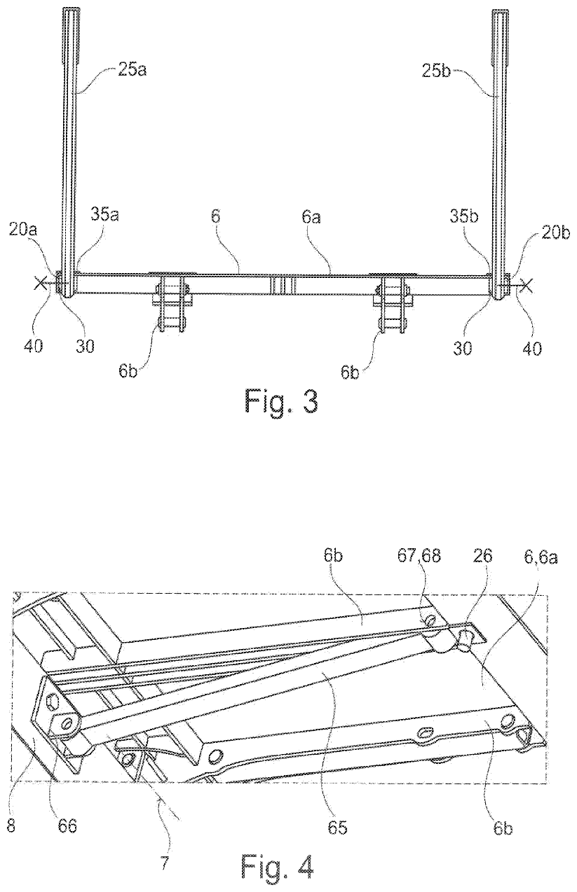

Each of the fastening interfaces 20a, 20b, 21—as shown in FIGS. 3, 5 and 6—is formed by a receptacle sleeve 30 located in the ramp plate 6, into which the additional stanchions 25a, 25 or the trailer hitch head 26 can be inserted from above. The ramp plate 6 consists of a cover plate 6a and stiffening braces 6b located underneath the cover plate 6a. The receptacle sleeves 30 are recessed in the cover plate 6a of the ramp plate 6 and are therefore located underneath the cover plate 6a.

The additional stanchions 25a, 25b and the trailer hitch head 26 are each provided with a stop flange 35a, 35b, 35c, respectively, with which, when inserted, the additional stanchions 25a, 25b and the trailer hitch head 26 are in contact with the top of the receptacle sleeve.

To secure the additional stanchions 25a, 25b and the trailer hitch head 26 when inserted into the receptacle sleeve 30, the additional stanchions 25a, 25b and the trailer hitch head 26 can each be secured in the receptacle sleeve 30 by means of a securing element. The securing element 40 is preferably a cotter pin, for example a spring cotter or linchpin, or a screwed-on lock nut.

In the illustrated exemplary embodiment, there are two fastening interfaces 20a, 20b located at some distance from each other in the transverse direction Q of the vehicle, to each of which an additional stanchion 25a, 25b in the form of a stanchion rod can be releasably fastened. The fastening interfaces 20a, 20b for the additional stanchions 25a, 25b are preferably located in the rear half of the ramp plate 6, on the outer sides of the ramp plate 6.

For the trailer hitch head 26, a fastening interface 21 located essentially centrally in the transverse direction Q of the vehicle is provided, and to which the trailer hitch head 26 is releasably fastened. The fastening interfaces 21 for the trailer hitch head 26 are located on the rear end of the ramp plate 6.

At least one hydraulic cylinder 50 is provided for the adjustment of the ramp plate 6 around the transverse axis 7 of the vehicle. In the illustrated exemplary embodiment, two hydraulic cylinders 50 are provided which are installed underneath the base plate 10 and are attached to the reinforcement braces 6b of the ramp plate 6 at some distance from the axis 7.

When the ramp plate 6 is lowered with its rear end on the ground, the ramp plate 6 contributes to the improved support of the working machine 1 when the rope winch 4 is used to pull a tree trunk toward the working machine 1. On the rear end of the ramp plate 6, for improved support on the ground, ground hooks that are not illustrated in any further detail are provided, which can be in the form of hooks, angle irons, stirrups or clamp-like grapples.

The hydraulic cylinders 50 can be actuated by means of a control valve which has a lifting position for lifting the ramp plate 6, a lowering position for lowering the ramp plate 6, and a floating position in which a ramp plate 6 lowered to the ground can follow the contour of the ground.

The control valve controlling the hydraulic cylinder 50 can further have a locked position to make it possible to hold the load on the ramp plate 6 in a selected position.

On the working machine 1 according to the invention, preferably simultaneous operation of the traction drive motors 3a, 3b and the hydraulic cylinder 50 that actuates the ramp plate 6 is possible, as a result of which the working machine 1 can effectively shake and push the tree trunks and position the ramp plate 6 as the working machine 1 travels.

At least one support strut 65 is provided to lock the ramp plate 6 in an essentially horizontal position for transport tasks, in which the ramp plate 6 is positioned as an extension of the base plate 10. In the illustrated exemplary embodiment, a support strut 65 is provided which is located essentially centrally in the transverse direction Q of the vehicle. When the ramp plate 6 is in the horizontal position, the support strut 65 is underneath the cover plate 6a of the ramp plate 6. The support strut 65 therefore supports the ramp plate 6 independently of the hydraulic cylinders 50, so that the hydraulic cylinders 50 are relieved of the forces exerted on the ramp plate 6 during transport tasks, and the ramp plate 6 is held in a desired position regardless of potential leaks in the hydraulic cylinders 50.

The support strut 65 is preferably in the form of a threaded strut, for example a double-threaded strut (top link).

The support strut 65 can be releasably fastened by means of bolted connections, which are not illustrated in any further detail, on a bearing flange 66 located on the rear end of the vehicle body 8 and on a bearing flange 67 of the ramp plate 6. The bearing flange 67 is preferably formed by bearing borings 68 for a bolt in a reinforcing brace 6b of the ramp plate located centrally in the transverse direction Q of the vehicle.

The additional stanchions 25a, 25b inserted into the fastening interfaces 20a, 20b thus form an additional row of stanchions on the ramp plate 6 in addition to the stanchion 5 on the base plate 10. The trailer hitch head 26 inserted into the fastening interface 21 forms a trailer device with which trailers can be towed when the working machine 1 is traveling in the forward direction. The working machine 1 preferably has a maximum width of 1.5 m, so that the working machine 1 can be transported to work sites on an automobile trailer.

The ramp plate 6 supported in the horizontal position by means of the support strut 65 thus forms a transport platform with an area of 2 m², for example, which extends the base plate 10 and makes it possible to transport a wide variety of goods, such as fences, water tanks, construction materials or agricultural goods, and to tow trailers.

The shape of the ramp plate 6, in particular the shape of the cover plate 6a of the ramp plate 6, can be selected to suit the principal application of the working machine 1. In addition to a flat shape of the cover plate 6a, the cover plate 6a can also be bent downward in the longitudinal direction L of the vehicle, to make possible the improved loading of a tree trunk and improved transport of a tree trunk, or alternatively bent upward in the longitudinal direction L of the vehicle, to make possible an improved winching of a tree trunk from a slightly inclined direction.

1. A mobile forestry machine, comprising a chassis, a drive unit, a rope winch, a stanchion and an adjustable ramp plate located on the rear end of a vehicle body, wherein the working machine does not have a driver workplace for an operator and is a remotely-controlled working machine, and wherein the ramp plate is provided with at least one fastening interface, to which an additional stanchion can be releasably fastened, and/or the ramp plate is provided with a fastening interface to which a trailer hitch head can be releasably fastened.

2. The mobile forestry machine according to claim 1, wherein the fastening interface is formed by a receptacle sleeve located in the ramp plate, into which the additional stanchion and/or the trailer hitch head can be inserted and which is recessed into the ramp plate.

3. The mobile forestry machine according to claim 2, wherein the additional stanchions and/or the trailer hitch head are each provided with a stop flange with which, when inserted, the additional stanchions and/or the trailer hitch head are in contact with the top of the receptacle sleeve.

4. The mobile forestry machine according to claim 2, wherein the additional stanchion and/or the trailer hitch head can be secured with a locking element in the receptacle sleeve.

5. The mobile forestry machine according to claim 1, wherein two fastening interfaces are provided at a distance from each other in a transverse direction of the vehicle, to each of which an additional stanchion can be releasably fastened.

6. The mobile forestry machine according to claim 1, wherein a fastening interface oriented substantially in a transverse direction of the vehicle is provided, to which an additional stanchion can be releasably fastened.

7. The mobile forestry machine according to claim 1, wherein the ramp plate can be supported by at least one support strut in a substantially horizontal position on the vehicle body of the working machine.

8. The mobile forestry machine according to claim 7, wherein the support strut is in the form of a threaded strut.

9. The mobile forestry machine according to claim 7, wherein the support strut can be releasably fastened by a bolted connection to the vehicle body and to the ramp plate by a bolted connection.

10. The mobile forestry machine according to claim 1, wherein the adjustable ramp plate is located on the rear end of the working machine so as to be adjusted around a horizontal transverse axis of the vehicle.

11. The mobile forestry machine according to claim 1, wherein the adjustable ramp plate can be adjusted around the transverse axis of the vehicle by at least one hydraulic cylinder.

12. The mobile forestry machine according to claim 11, wherein the hydraulic cylinder can be actuated by a control valve that has a floating position.

13. The mobile forestry machine according to claim 1, wherein the stanchion has two vertical stanchion rods located at a distance from each other in a transverse direction of the vehicle and can be rotated around a vertical axis.

14. The mobile forestry machine according to claim 1, wherein a cross brace is located on the vehicle body in a longitudinal direction of the vehicle between the stanchion and the ramp plate.

15. The mobile forestry machine of claim 4, wherein the locking element is a cotter pin or lock nut.

16. The mobile forestry machine according to claim 8, wherein the support strut is in the form of a double threaded rod.
